(19) United States
(12) Patent Application Publication
(10) Pub. No.: US 2026/0187943 A1
(43) Pub. Date: Jul. 2, 2026

(54) SYSTEM AND METHOD FOR PLACEMENT OF DIGITAL OBJECTS

(71) Applicant: Flying Flamingos India Private Limited, Bangalore (IN)

(72) Inventors: Amit Gaiki, Bangalore (IN); Shourya Agarwal, Ajmer (IN); Malhar Patil, Nagpur (IN); Divyansh Gupta, Banswara (IN)

(73) Assignee: Flying Flamingos India Private Limited, Bangalore, KA (IN)

(21) Appl. No.: 19/435,903

(22) Filed: Dec. 30, 2025

(30) Foreign Application Priority Data
Dec. 30, 2024 (IN) 202441104501

(51) Int. Cl. G06T 19/00; G06F 21/53

(52) U.S. Cl. CPC G06T 19/006; G06F 21/53

(57) ABSTRACT

The present invention provides system executing dynamic mixed reality experiences on user device including processors and non-transitory memory storing instruction receiving trigger signals from user interaction with trigger mechanisms through user devices. Trigger mechanisms comprise universal access links invoking instant applications without installation. System activates modular mixed reality engine dynamically loading mixed reality modules and digital assets, executing instant applications within sandboxed runtime environments using secure execution frameworks. System enables context-aware, dynamic, adaptive integration of virtual elements into physical environment displayed through user interfaces using real-time physical environment data and spatial analysis. Mixed reality experiences render on adaptive interactive user interfaces enabling dynamic digital placement, manipulation, transformation of virtual elements adjusted dynamically before and during rendering based on real-time physical environment data, spatial analysis, hardware-software configurations. System improves device functioning minimizing computational, overhead sandboxed execution, reducing launch latency via instant application invocation, enabling secure, adaptive, spatially consistent digital object interaction.

### TECHNICAL FIELD

The present invention relates to the field of mixed reality systems and methods. Specifically, it relates to systems and methods for placing and interacting with digital objects in an instant app experience within a mixed reality environment.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to implementations of the claimed technology.

The rapid development of Mixed Reality (MR) technologies has significantly advanced the ability to blend physical and digital worlds. These technologies enable users to interact with virtual objects in real time within their physical environments. MR, which incorporates elements of both Augmented Reality (AR) and Virtual Reality (VR), offers unique opportunities to create immersive, interactive experiences. However, despite these advancements, delivering a seamless and scalable MR experience remains a challenge. This challenge is even more evident when it comes to integrating digital content in lightweight, instant application experiences across multiple platforms such as Android, iOS, Windows, and the web.

Traditional MR applications require full installation on a device, leading to platform-specific solutions that do not offer true interoperability. This approach presents significant barriers to users, as it limits the accessibility of MR content across devices, creating friction in user adoption. Furthermore, developers face the challenge of maintaining different application versions for each platform, which increases development and maintenance costs. For users seeking an immediate MR experience, the need to install a dedicated application can be a deterrent, undermining a potential for broader engagement with MR technologies.

Instant apps have emerged as a solution to reduce these barriers. The instant apps enable users to access MR experiences without needing full installation. While instant apps lower the friction for entry, they often come with limitations such as latency, resource constraints, and security vulnerabilities. These issues are particularly pronounced when rendering dynamic 3D content in MR environments, where real-time performance and responsiveness are essential. The need for efficient, adaptive, and resource-optimized 3D rendering systems within instant apps is critical to provide a high-quality MR experience that can meet the expectations of users.

Another key challenge is the ability to place and interact with digital content in real-world spaces within the context of an Instant App Experience. Traditional MR systems often fail to allow users to dynamically and intuitively place digital objects within the physical environment. This lack of real-time, adaptive interaction limits the immersive potential of MR experiences. A user should be able to seamlessly place, adjust, and manipulate digital objects within their physical surroundings without the need for complex setups or extensive prior configurations.

Furthermore, existing MR systems do not frequently leverage the full capabilities of device sensors, such as accelerometers, gyroscopes, and cameras, to dynamically respond to changes in the physical environment. For example, camera-based spatial mapping and real-time tracking of the user's movements are often underutilized, resulting in a lack of responsiveness in MR interactions. This failure to integrate sensor data limits the realism of digital objects, preventing them from reacting to user movements in a natural and intuitive manner. Consequently, users experience a disjointed and less engaging interaction, which detracts from the immersive potential of MR technologies.

There is, therefore, a significant need for an invention that addresses these limitations.

### SUMMARY

In an aspect, the present invention provides a system for executing dynamic mixed reality experience on a user device. The system includes one or more processors and a non-transitory memory storing instructions that, when executed by the one or more processors, cause the system to receive a trigger signal associated with interaction of a user with a trigger mechanism through a user device. In addition, the trigger mechanism comprises a device-agnostic universal access link configured to, upon the user interaction, invoke an instant application on the user device without requiring installation. Moreover, in response to the received trigger signal, the system activates a modular mixed reality engine configured to dynamically load a plurality of mixed reality modules and digital assets execute, using a secure execution framework, the instant application within a sandboxed runtime environment on the user device by leveraging the dynamically loaded mixed reality modules and digital assets. Further, the system enables using the modular mixed reality engine, context-aware, dynamic, and adaptive integration of one or more virtual elements into a physical environment displayed through a user interface of the user device. The integration is performed based on real-time physical environment data and real-time spatial analysis of the physical environment. Moreover, the system renders the mixed reality experience with the integrated one or more virtual elements on an adaptive and interactive user interface of the user device. The rendering includes enabling dynamic digital placement, manipulation, and transformation of the one or more virtual elements. The mixed reality experience is dynamically adjusted before rendering and during rendering based on the real-time physical environment data, the real-time spatial analysis, and a hardware and software configuration of the user device. Furthermore, the system enables improved functioning of the user device by minimizing computational overhead through the sandboxed execution, reducing launch latency by invoking the instant application, and enabling secure, adaptive, and spatially consistent digital object interaction based on the real-time spatial analysis.

In an embodiment of the present disclosure, the system further the system enables the rendering of an instant, on-demand mixed reality experience without requiring a full application download or redirection to an application storage database.

In an embodiment of the present disclosure, the system enables the instant, on-demand mixed reality experience that includes intercepting a request to access the universal access link and in response to user approval through a user interface prompt, activating the modular mixed reality engine.

In an embodiment of the present disclosure, the trigger mechanism is associated with embedded metadata related to the mixed reality experience. The embedded metadata comprises at least one of a mixed reality experience identifier, asset locations, or one or more parameters controlling the mixed reality experience.

In an embodiment of the present disclosure, the one or more virtual elements includes at least one digital object placed into the physical environment. The integration of the at least one digital object includes capturing the physical environment data from a set of hardware components associated with the user device. Further, the system performs the real time spatial analysis of the physical environment by analysing the on the physical environment data using one or more computer vision algorithms. Moreover, the system includes generating a spatial map of the physical environment based on the real-time spatial analysis. The spatial map represents at least one of one or more surfaces, one or more objects, one or more boundaries, and one or more reference points and determining one or more positions for placing the at least one digital object within the physical environment based on the spatial map and one or more contextual parameters.

In an embodiment of the present disclosure, the integration of the at least one digital object includes persistently anchoring the at least one digital object to the one or more surfaces or the one or more objects in the physical environment such that spatial position and orientation of the at least one digital object remains aligned with the physical environment.

In an embodiment of the present disclosure, the determining of the one or more positions includes evaluating the one or more contextual parameters. The one or more contextual parameters includes at least an object type, an environment type, spatial constraints in the physical environment, device state, and derived user intent.

In an embodiment of the present disclosure, the dynamic placement, the manipulation, and the transformation includes changing position, altering size, changing orientation, changing texture, or replacing the one or more virtual elements.

In an embodiment of the modular mixed reality engine dynamically loads or unloads one or more mixed reality modules based on monitored system resources and user interaction context. The monitored system resources comprise at least CPU utilization, GPU utilization, battery state, network conditions, or thermal thresholds.

In an embodiment of the present disclosure, the trigger signal is generated through the user interaction and the user interaction includes one of at least scanning of a quick response (QR) code through a camera of the user device, clicking on a hyperlink received on the user device, detection of a near field communication (NFC) tag through the user device, reception of a voice input through the user device and recognition of a gesture input provided by the user.

In an embodiment of the present disclosure, the real-time spatial analysis comprises identifying surfaces, boundaries, reference points, or object geometries within the physical environment.

In an embodiment of the present disclosure, the physical environment data comprises at least one or a combination of image data, depth data, and inertial data.

In another aspect, a computer-implemented method is disclosed. The computer-implemented method performs execution of a dynamic mixed reality experience on a user device. The computer-implemented method incudes receiving a trigger signal associated with interaction of a user with a trigger mechanism through the user device. The trigger mechanism includes a device-agnostic universal access link configured to, upon the user interaction, invoke an instant application without requiring installation. Further, in response to the trigger signal, the computer-implemented method includes activating a modular mixed reality engine configured to dynamically load a plurality of mixed reality modules and digital assets and executing, using a secure execution framework, the instant application within a sandboxed runtime environment on the user device using the dynamically loaded mixed reality modules and digital assets. Moreover, the computer-implemented method includes enabling, using the modular mixed reality engine, context-aware, dynamic, and adaptive integration of one or more virtual elements into a physical environment displayed through an adaptive user interface on the user device. The integration is based on real-time physical environment data and real-time spatial analysis and rendering the mixed reality experience with the integrated one or more virtual elements on an adaptive and interactive user interface of the user device. The rendering comprises enabling dynamic digital placement, manipulation, and transformation of the one or more virtual elements. The mixed reality experience is dynamically adjusted before rendering and during rendering based on the real-time physical environment data, the real-time spatial analysis, and a hardware and software configuration of the user device.

In yet another aspect, a non-transitory computer-readable medium is disclosed. The non-transitory computer-readable medium stores instructions that, when executed by one or more processors, cause a system to perform a method for detecting and classifying shadows in a physical environment in real time. The method includes a first step of receiving a trigger signal associated with interaction of a user with a trigger mechanism through the user device. The trigger mechanism includes a device-agnostic universal access link configured to, upon the user interaction, invoke an instant application without requiring installation. Further, in response to the trigger signal, the method includes activating a modular mixed reality engine configured to dynamically load a plurality of mixed reality modules and digital assets and executing, using a secure execution framework, the instant application within a sandboxed runtime environment on the user device using the dynamically loaded mixed reality modules and digital assets. Moreover, the method includes enabling, using the modular mixed reality engine, context-aware, dynamic, and adaptive integration of one or more virtual elements into a physical environment displayed through an adaptive user interface on the user device. The integration is based on real-time physical environment data and real-time spatial analysis and rendering the mixed reality experience with the integrated one or more virtual elements on an adaptive and interactive user interface of the user device. The rendering includes enabling dynamic digital placement, manipulation, and transformation of the one or more virtual elements. The mixed reality experience is dynamically adjusted before rendering and during rendering based on the real-time physical environment data, the real-time spatial analysis, and a hardware and software configuration of the user device.

### BRIEF DESCRIPTION OF DRAWINGS

Having thus described the disclosure in general terms, references will now be made to the accompanying figures, wherein:

FIG. 1 illustrates an interactive computing environment for executing a dynamic mixed reality experience on a user device, in accordance with various embodiments of the present disclosure;

FIG. 2 illustrates an exemplary distributed computing environment for executing the dynamic mixed reality experience on the user device, in accordance with various embodiments of the present disclosure;

FIG. 3 illustrates a screenshot of an exemplary instant application interface showing a co-created mixed reality content, in accordance with an embodiment of the present disclosure;

FIG. 4 illustrates another screenshot of an exemplary instant application interface showing another mixed reality content, in accordance with an embodiment of the present disclosure;

FIG. 5 illustrates a flow chart of a method for executing the dynamic mixed reality experience on the user device, in accordance with various embodiments of the present disclosure; and

FIG. 6 illustrates a block diagram of an exemplary device configured for executing the dynamic mixed reality experience on the user device, in accordance with various embodiments of the present disclosure.

It should be noted that the accompanying figures are intended to present illustrations of exemplary embodiments of the present disclosure. These figures are not intended to limit the scope of the present disclosure. It should also be noted that accompanying figures are not necessarily drawn to scale.

### DETAILED DESCRIPTION OF INVENTION

Some embodiments of the disclosure, illustrating all its features, will now be discussed in detail. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise. Although any systems and methods similar or equivalent to those described herein can be used in the practice or testing of embodiments of the present disclosure, the preferred, systems and methods are now described. Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

While the present invention is described herein by way of example using embodiments, those skilled in the art will recognize that the invention is not limited to the embodiments described and are not intended to represent the scale of the various components. It should be understood that the detailed description thereto is not intended to limit the invention to the particular form disclosed, but on the contrary, the invention is to cover all modifications, equivalents, and alternatives falling within the scope of the present invention as defined by the appended claim. As used throughout this description, the word “may” is used in a permissive sense (i.e. meaning having the potential to), rather than the mandatory sense, (i.e. meaning must). Further, the words “a” or “an” mean “at least one” and the word “plurality” means “one or more” unless otherwise mentioned. Furthermore, the terminology and phraseology used herein is solely used for descriptive purposes and should not be construed as limiting in scope. Language such as “including,” “comprising,” “having,” “containing,” or “involving,” and variations thereof, is intended to be broad and encompass the subject matter listed thereafter, equivalents, and additional subject matter not recited, and is not intended to exclude other additives, components, integers, or steps. Likewise, the term “comprising” is considered synonymous with the terms “including” or “containing” for applicable legal purposes. Any discussion of documents, acts, materials, devices, articles, and the like is included in the specification solely for the purpose of providing a context for the present invention. It is not suggested or represented that any or all of these matters form part of the prior art base or were common general knowledge in the field relevant to the present invention.

The present invention is described hereinafter by various embodiments. This invention may, however, be embodied in many different forms and should not be construed as limited to the embodiment set forth herein. Rather, the embodiment is provided so that this disclosure will be thorough and complete and will fully convey the scope of the invention to those skilled in the art. In the following detailed description, numeric values and ranges are provided for various aspects of the implementations described. These values and ranges are to be treated as examples only, and are not intended to limit the scope of the claims. In addition, a number of system architectures are identified as suitable for various facets of the implementations. These system architectures are to be treated as exemplary and are not intended to limit the scope of the invention.

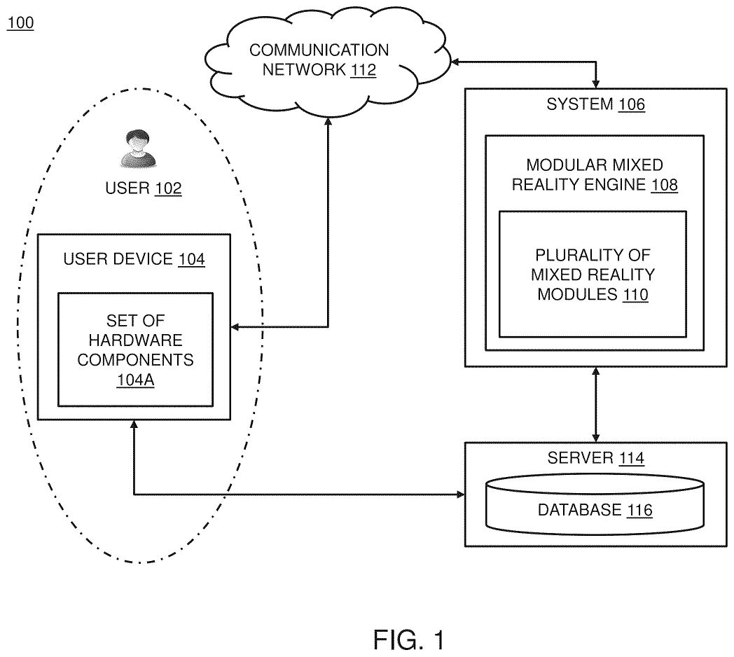

FIG. 1 illustrates an interactive computing environment 100 for executing a dynamic mixed reality experience on a user device 104, in accordance with various embodiments of the present disclosure. The interactive computing environment 100 enables rendering of the mixed reality experience on the user device 104. The interactive computing environment 100 includes a user device 104 associated with a user 102, a system 106, a communication network 112, a server 114 and a database 116. The user device 104 interacts with the system 106 via the communication network 112. The components of the interactive computing environment 100 collectively operate to execute the dynamic mixed reality experience on the user device 104. In addition, the components of the interactive computing environment 100 collectively operate to render the mixed reality experience on the user device 104. The components of the interactive computing environment 100 are operatively coupled and cooperatively function to enable dynamic deployment, and rendering of the mixed reality content tailored to contextual and device-specific conditions.

The mixed reality experience refers to a digitally enhanced immersive environment that blends virtual objects or augmentations with the physical world or environment in real time. The mixed reality experience allows the user 102 to perceive and interact with at least one or more digital and one or more physical components in a spatially and temporally coherent manner. The mixed reality content encompasses at least digital assets, virtual objects, holograms, spatial audio, interactive controls, and context-sensitive information rendered within the mixed reality experience. The mixed reality content is rendered in real time based on user input, environmental conditions, sensor data, and device capabilities. In addition, the mixed reality content includes dynamic overlays, gesture-responsive elements, or real-world object annotations.

In an embodiment of the present disclosure, the user device 104 refers to any suitable user equipment configured to receive, render, and interact with the mixed reality content. Examples of the user device 104 include a smartphone, tablet, smart glasses, wearable computing device, augmented reality (AR) headsets, and the like. Additionally, the user device 104 may host a runtime environment capable of executing instant or transient mixed reality modules without requiring full application installation.

The user 102 may represent an individual interacting with the mixed reality content through the user device 104. The user 102 may initiate mixed reality experiences by scanning a QR code, clicking an app link, or triggering the modular mixed reality engine 108 via other scannable or link-based mechanisms.

The system 106 may further include one or more processors, memory units, and a rendering engine configured to generate and deliver the mixed reality content to the user device 104. The rendering engine may leverage spatial mapping data, object recognition modules, or user-specific behavioral profiles to adapt the mixed reality content in real time. Additionally, the communication network 112 may include wired or wireless channels, such as 5G, Wi-Fi, or satellite links, to facilitate low-latency content synchronization and interaction. The server 114 may manage user sessions, content orchestration, and system-wide updates, while the database 116 may store user profiles, contextual data, device parameters, and pre-rendered or modular content components.

In an embodiment of the present disclosure, the system 106 includes a modular mixed reality engine 108. The modular mixed reality engine 108 includes a plurality of mixed reality modules 110. The modular mixed reality engine 108 orchestrates loading of at least one module of the plurality of mixed reality modules 110 in real-time. The dynamic loading of the at least one module is done based at least on one or more user interactions and environmental data. The dynamic loading features ensures an optimized performance and user experience. In an implementation, the modular mixed reality engine 108 may be a modular and platform-agnostic MR engine. The system 106 allows seamless deployment of the mixed reality content by leveraging real-time context awareness, dynamic module loading, and lightweight instant applications. The instant application enables the mixed reality experience without the need for a full application download and installation on the user device 104.

In another embodiment of the present disclosure, the modular mixed reality engine 108 may orchestrate unloading of at least one module of the plurality of mixed reality modules 110 in real-time. The dynamic unloading of the at least one module is done based at least on one or more user interactions and environmental data. The dynamic loading features ensures an optimized performance and user experience. In an implementation, the modular mixed reality engine 108 may be a modular and platform-agnostic MR engine.

The plurality of mixed reality modules 110 operate within a kernel-level application sandbox or a secure sandbox environment in a Linux-based system to provide security and efficiency. In an embodiment of the present disclosure, the secure sandbox environment is established through context-aware permission management and a secure execution framework. The secure sandbox environment ensures at least security and stability during the rendering of the mixed reality content.

In an embodiment of the present invention, the system 106 enables adaptive data streaming for adjusting data streaming rates based on network conditions and device performance while integrating edge computing for efficiency. In an embodiment of the present disclosure, the system 106 enables a cross-module communication for facilitating real-time data exchange between at least two modules of the plurality of mixed reality modules 110. In addition, the cross-module communication enhances realism of the mixed reality experience through seamless interaction between 2D alpha content and 3D environment mapping.

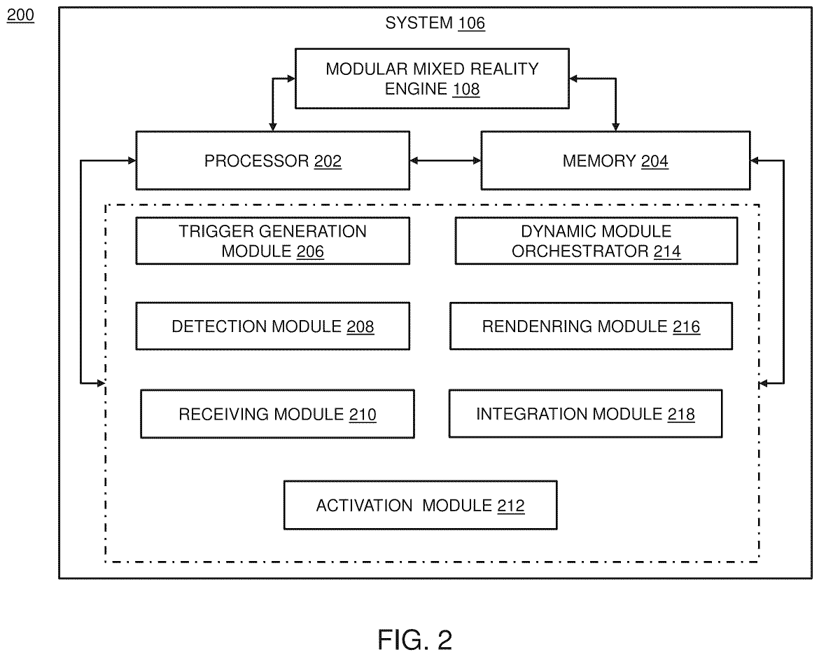

The user device 104 works in conjunction with the system 106, the server 114 and the modular mixed reality engine 108 to perform a set of functions. The set of functions include at least reception of contextual data, dynamically loading appropriate mixed reality modules, and rendering immersive content responsive to real-time user interactions and environmental conditions (explained further below in the detailed description of FIG. 2).

The communication network 112 serves as the backbone of the interactive computing environment 100, enabling seamless communication between the user device 104, the system 106, the server 114 and the database 116. Various entities in the environment 100 may connect to the communication network 112 in accordance with various wired and wireless communication protocols, such as Transmission Control Protocol and Internet Protocol (TCP/IP), User Datagram Protocol (UDP), 2nd Generation (2G), 3rd Generation (3G), 4th Generation (4G), 5th Generation (5G), 6th Generation (6G) communication protocols, Long Term Evolution (LTE) communication protocols, future communication protocols or any combination thereof.

The communication network 112 provides an infrastructure for seamless communication between the user device 104, the system 106, the server 114 and the database 116. In some implementations, the communication network 112 includes internet, intranet, Wi-Fi, or other wired or wireless communication technologies.

The server 114 may refer to a backend processing system or a cloud-based infrastructure configured to coordinate, manage, and support the delivery of mixed reality content to the user device 104. In an embodiment of the present disclosure, the server 114 includes one or more computing devices configured to manage backend operations. The operations include but are not limited to, processing user requests, storing and updating MR content modules, and executing cloud-based rendering operations. In addition to above, the server 114 may manage user sessions and maintain communication with the user device 104. The server 114 may incorporate application programming interfaces (APIs), load-balancing modules, analytics engines, and orchestration logic to dynamically coordinate mixed reality experiences across users and devices.

In an embodiment of the present disclosure, the server 114 is associated with one or more remote computing entities. The one or more remote computing entities are responsible for facilitating core services required for managing and supporting the delivery of the mixed reality (MR) experiences. The server 114 operates as an orchestrator that communicates with the system 106 and the user device 104 over the communication network 112. In one example, the server 114 may host APIs, decision engines, and application services configured to process user interactions, manage MR session states, authenticate user access, and deliver relevant MR content modules to downstream components.

In certain implementations, the server 114 may enforce access controls, implement deployment policies, and manage caching of frequently accessed MR assets to enhance responsiveness and delivery speed. The server 114 plays a key role in mediating communication between the modular mixed reality engine 108 on the user device 104 and the backend infrastructure. The server 114 enables seamless synchronization and dynamic loading of mixed reality modules across heterogeneous client platforms.

In an embodiment of the present disclosure, the server 114 and the system 106 are architecturally distinct but interoperable components of the interactive computing environment 100. The server 114 and the system 106 perform complementary functions to facilitate MR content delivery and interaction. The server 114 acts as a backend orchestrator and processing layer, implemented using centralized or distributed cloud resources. It is configured to manage session states, execute intensive computational operations such as spatial computation and scene analysis, personalize MR content, and transmit context-aware MR assets to client-side rendering components.

The server 114 may refer to a backend processing system or cloud-based infrastructure that coordinates, manages, and supports the rendering of the mixed reality content delivered to the user device 104. In an embodiment of the present disclosure, the server 114 and the system 106 represent architecturally distinct yet interoperable components of the interactive computing environment 100. Each of the server 114 and the system 106 are configured to perform complementary functions in support of the mixed reality content delivery and interaction. The server 114 functions as a backend processing and orchestration layer, implemented as a cloud-based infrastructure or centralized computing resource. The server 114 is configured to manage user sessions, perform computationally intensive operations such as spatial computation, scene understanding, and MR content personalization, and deliver contextually relevant MR assets to client-side components.

The server 114 may host, manage and remotely execute an instant application mechanism for enabling the dynamic delivery of one or more mixed reality modules and ensuring platform and device independent user experiences. The server 114 may serve as an edge computing or localized processing layer that interfaces directly with the user device 104. The server 114 is configured to handle real-time operations. The operations include at least adaptive user interface control, haptic feedback coordination, sensor data ingestion, and latency-sensitive mixed reality content rendering.

In an example implementation of a distributed computing environment and shown in FIG. 1, the system 106 is operatively connected to the server 114. The server 114 hosts a database 116. The server 114 handles client requests and provides necessary data to the system 106 for further processing and rendering of mixed reality content. The system 106 and the server 114 are communicatively coupled via the communication network 112. The system 106 and the server 114 cooperatively function to enable scalable, immersive, and responsive mixed reality experiences across heterogeneous devices and usage contexts.

In another example implementation, the system includes or is operatively connected to the database 116 for storing localized content or cached user session data (not shown in illustration). The system 106 includes a modular mixed reality engine and is operatively connected to a server 114 hosting a database 116. The server 114 handles client requests and provides necessary data to the system 106 for further processing and rendering of mixed reality content.

The system 106 may include a combination of software components, processing units, micro services, or virtualized containers that handle multiple tasks. The tasks include module selection, compatibility evaluation, mixed reality asset delivery, spatial computation, and the like. The system 106 herein may represent a cloud server, an edge computing node, or a centralized processing system. In an embodiment of the present disclosure, the system 106 includes the database 116. In another embodiment, the database 116 is associated and remotely connected to the system 106. In one implementation, the system 106 may include one or more server-grade machines or distributed cloud-based computing resources configured to perform the rendering of the mixed reality content. The system 106 may further include a plurality of software modules and processing components operative to execute the rendering of the mixed reality content. In an example implementation scenario, the rendering may include data pre-processing, feature extraction, segmentation model inference, and post-processing operations.

The database 116 refers to one or more data storage systems that store structured and unstructured information necessary for supporting and rendering the mixed reality experience. In an embodiment of the present disclosure, the database 116 herein may correspond to a non-transitory storage system caused to persistently store real time information for the rendering of the mixed reality content. The database 116 may include at least mixed reality module repositories, user profiles, mixed reality experience identifiers (IDs), device compatibility matrices, content metadata, and environmental context logs. In addition, the database 116 may contain pre-trained machine learning models used for dynamic prediction of mixed reality modules. The database 116 enables real-time data retrieval and synchronization across the system 106 and the server 114 to ensure that relevant mixed reality assets are efficiently selected, delivered, and rendered at the user device 104. The database 116 may be implemented as a distributed cloud database or a hybrid architecture to support scalability, redundancy, and low-latency data access.

The database 116 herein may correspond to a collection of information that is organized so that it can be easily accessed, managed and updated. In some implementations, the database 116 may include relational databases, NoSQL databases, cloud-based databases, graph databases, in-memory databases, and the like.

In an embodiment of the present disclosure, the server 114 exists as an external host for the system 106 (as shown in FIG. 1). The database 116 may be integrated within the server 114. In another embodiment, the server 114 may host the system 106 (not shown in FIG. 1). The database 116 may be integrated within the server 114 for retrieving at least mixed reality assets, spatial data, and user interaction logs.

It is shown in FIG. 1 that a single user (the user 102) interacts with a single device (the user device 104); however, it will be appreciated by those skilled in the art that any number of users 102 can simultaneously interact with the corresponding devices in real-time.

The number and arrangement of systems, and/or networks shown in FIG. 1 are provided as an example. There may be additional systems, devices, and/or networks; fewer systems, devices, and/or networks; different systems, devices, and/or networks, and/or differently arranged systems, devices, and/or networks than those shown in FIG. 1. Furthermore, two or more systems or devices shown in FIG. 1 may be implemented within a single system or device, or a single system or device shown in FIG. 1 may be implemented as multiple, distributed systems or devices. Additionally, or alternatively, a set of systems or a set of devices of the interactive computing environment 100 may perform one or more functions described as being performed by another set of systems or another set of devices of the interactive computing environment 100.

FIG. 2 illustrates an exemplary block diagram 200 of a system 106 configured to execute a dynamic mixed reality (MR) experience on a user device 104. The system 106 includes a processor 202, a memory 204, a modular mixed reality engine 108, and a plurality of specialized software-implemented functional modules, including a trigger generation module 206, a detection module 208, a receiving module 210, an activation module 212, a dynamic module orchestrator 214, a rendering module 216, and an integration module 218. Each of the aforementioned modules is operatively coupled to the modular mixed reality engine 108 and configured to collectively enable a context-aware, device-agnostic mixed reality experience without necessitating prior installation of a dedicated application.

The processor 202 includes one or more computing units operable to execute instructions stored within the memory 204. The memory 204 includes a combination of volatile and non-volatile memory elements. The memory 204 is configured to store decoded metadata associated with MR triggers, manifest files for MR modules, rendering instructions, session-specific identifiers, environmental sensor data, and runtime configuration files. The processor 202 is further operable to manage control flow across modules, synchronize execution of tasks associated with MR rendering, evaluate device-level constraints including battery and thermal parameters, and initiate fallback procedures in accordance with runtime conditions.

The trigger generation module 206 is configured to generate one or more platform-agnostic trigger mechanisms capable of initiating execution of an instant MR application. The trigger generation module 206 is operable to systematically convert predefined parameters related to a target MR experience into one or more launchable formats. The MR experience is invoked without necessitating installation of a standalone application. The trigger generation module 206 receives experience definition parameters either from a content authoring interface, a remote content management service, or a local configuration registry. Upon receiving configuration parameters, the trigger generation module 206 assigns a unique mixed reality experience identifier and associates one or more uniform resource locators (URLs) or access pointers corresponding to MR asset repositories. In addition, the trigger generation module 206 defines session-specific control parameters governing behaviour of the MR experience. The behaviour control parameters may include environment-specific constraints, allowed sensor access permissions, session timeout duration, animation presets, content filtering rules, and real-time rendering directives.

The trigger generation module 206 is further configured to encode the above-mentioned parameters in one or more transportable formats compatible with trigger detection on the user device 104. The encoded trigger may be formatted as a quick response (QR) code that graphically represents the metadata in a binary or alphanumeric encoded structure conforming to ISO/IEC 18004 standard. In another embodiment, the trigger generation module 206 encodes the metadata within a secure hyperlink formatted for invocation by web-based execution frameworks, where the hyperlink includes a base URL, one or more embedded query parameters, and an encrypted token. In another embodiment, the trigger generation module 206 generates a near field communication (NFC) tag payload containing one or more metadata fields defined according to the NFC Data Exchange Format (NDEF). The payload is written to a physical NFC tag and is configured to activate the mixed reality engine upon proximity-based detection by the user device 104.

In some implementations, the trigger generation module 206 may generate voice or gesture-based triggers. The voice trigger may include a digital signature pattern generated from a user-defined voice command, processed using a keyword extraction model and matched against pre-trained acoustic templates stored in memory 204. The gesture trigger includes a sequence of motion vectors captured from a reference inertial measurement unit (IMU) dataset, where the motion pattern is encoded and assigned to a gesture ID representing a known MR session configuration. Each generated trigger is uniquely bound to the encoded MR metadata, validated using a checksum or hash function to prevent unauthorized alteration, and optionally timestamped or location-locked using cryptographic tokens to enforce spatiotemporal restrictions.

In exemplary embodiments, the trigger generation module 206 is operable to batch generate multiple trigger instances linked to a common MR experience. Each trigger may differ in terms of usage context, display form factor, or localization parameters such as language or region. For example, a retail brand may utilize the trigger generation module 206 to produce distinct QR codes for different stores or product displays, each configured to invoke a localized MR advertisement corresponding to inventory available at the respective retail location. In another example, the trigger generation module 206 generates a short-duration hyperlink valid only during a live event broadcast, thereby restricting access to time-sensitive MR interactions.

Further, the trigger generation module 206 supports integration with third-party systems including advertisement platforms, enterprise applications, and educational content management systems. The generated trigger may be embedded in digital assets such as banner ads, email templates, or online learning modules. In an embodiment, the trigger generation module 206 generates an output that is digitally signed and stored in association with a metadata registry or a trigger analytics engine. The trigger analytics engine tracks various metrics, including activation frequency, geographic distribution, device type metrics, and user interaction patterns, while ensuring that no personally identifiable information is stored or exposed. Each trigger mechanism generated by the trigger generation module 206 is configured to seamlessly enable execution of an MR experience through the modular mixed reality engine 108, in a secure, installation-free manner. Also, each mechanism is consistent with the operational objective of delivering platform-neutral, dynamic and context-aware MR content.

In an embodiment of the present disclosure, the detection module 208 is configured to identify user interaction events associated with one or more trigger mechanisms generated by the trigger generation module 206. The detection module 208 classifies the corresponding trigger types based on signal modality and encoding structure. The detection module 208 includes a plurality of input monitoring subcomponents configured to continuously or conditionally observe user interaction channels including optical, proximity-based, inertial, and acoustic inputs. Upon receipt or sensing of a user interaction signal, the detection module 208 initiates a decoding sequence to extract embedded metadata and prepares the extracted content for subsequent processing by the receiving module 210.

The detection module 208 includes an optical decoding subcomponent configured to acquire visual representations of graphical triggers, such as QR codes or fiducial markers, through one or more image acquisition units associated with the user device 104. The optical decoding subcomponent processes each frame using a pattern recognition pipeline that applies binarization, geometric distortion correction, orientation estimation, and data symbol interpretation in compliance with industry-standard decoding formats. Upon successful decoding, the optical decoding subcomponent extracts alphanumeric payloads comprising metadata required to instantiate the mixed reality session.

The detection module 208 further includes an NFC signal monitoring subcomponent operable to detect proximity-based interactions with NFC tags. The NFC subcomponent interfaces with the NFC reader hardware of the user device 104 to monitor for ambient magnetic field signatures and triggers a polling response upon successful proximity detection. The NFC subcomponent then, extracts encoded metadata from the tag's payload in accordance with the NFC Forum's NDEF specifications. The detection module 208 additionally includes a gesture recognition subcomponent configured to identify user-performed gestures based on sensor fusion of accelerometer, gyroscope, and magnetometer data acquired from the user device 104. The gesture recognition subcomponent segments and transforms the raw motion data into a normalized vector representation. The gesture recognition subcomponent compares the extracted signal pattern against one or more predefined templates using dynamic time warping or neural classification methods. Then, the gesture recognition subcomponent associates the identified gesture with a stored metadata profile linked to a specific mixed reality experience.

In some embodiments, the detection module 208 further includes an acoustic trigger detection subcomponent configured to process microphone input in real-time and identify trigger phrases or sound cues. The acoustic trigger detection subcomponent utilizes a voice activity detector followed by a keyword spotter model trained to detect specific phonetic patterns. Upon detection of a qualifying acoustic signal, the subcomponent invokes a decoding engine to retrieve the associated mixed reality metadata, either directly from the voice signal or via a look-up based on the recognized command. Following signal classification and decoding, the detection module 208 executes a metadata validation procedure to ensure compliance of the extracted information with predefined security, compatibility, and content policy constraints. The validation procedure may include digital signature verification, content schema validation, cross-referencing with a whitelist or certificate authority, and device capability checks to ensure the extracted metadata is actionable by system 106. Upon successful validation, the detection module 208 packages the decoded and verified metadata into a standardized format and transmits the same to the receiving module 210 for subsequent operations.

In exemplary implementations, the detection module 208 supports multi-modal trigger reception, where simultaneous or sequential detection across multiple input channels is permitted. For example, a combined trigger sequence may involve scanning a QR code while concurrently capturing a gesture input, where both signals are merged by the detection module 208 to enrich the contextual parameters passed downstream. In additional embodiments, the detection module 208 includes a trigger authenticity scoring engine that computes a confidence metric based on observed anomalies, environmental noise, or prior usage data, and dynamically adjusts the downstream processing pathway accordingly.

Furthermore, according to the present disclosure, the receiving module 210 as described with respect to FIG. 2 is configured to process the decoded metadata received from the detection module 208. The receiving module 210 initiates asset acquisition and configuration management procedures for executing a mixed reality (MR) experience on the user device 104. The receiving module 210 operates as a data ingress interface between the system 106 and one or more remote content delivery infrastructures, including a content server 114. Upon receiving validated metadata from the detection module 208, the receiving module 210 parses embedded references indicating the location of asset bundles. These references may include cloud-hosted storage endpoints, application programming interface (API) gateways, or decentralized content repositories.

The receiving module 210 initiates an authenticated connection with the content server 114 using authorization credentials or access tokens embedded within the decoded metadata. The receiving module 210 performs an integrity handshake and a permissions check to verify that the requested session parameters comply with security and usage policies associated with the modular mixed reality engine 108. Upon successful authorization, the receiving module 210 retrieves one or more runtime assets referenced in the metadata. The runtime assets include three-dimensional object meshes, hierarchical texture atlases, pre-authored animation scripts, and spatial configuration files. Each retrieved asset conforms to a predefined serialization format compatible with the rendering module 216 and the integration module 218.

The receiving module 210 is further configured to extract session-specific configuration parameters from the metadata. The parameters include session duration limits, device capability constraints, user interface layout instructions, input modality settings, and localization attributes such as language preferences and regional content variants. In some embodiments, the receiving module 210 may also retrieve auxiliary logic files including MR behaviour definitions, state transition graphs, and rule-based content modifiers. These files govern the real-time execution behaviour of the MR experience within the modular mixed reality engine 108.

The receiving module 210 stores the retrieved runtime assets and configuration files temporarily within the memory 204, allocating memory partitions based on asset priority, usage frequency, and data size characteristics. The memory allocation scheme applied by the receiving module 210 ensures optimized access times and prevents contention with other concurrently executing modules. For session-critical assets such as foundational spatial maps or high-resolution geometry files, the receiving module 210 applies a cache-locking mechanism to prevent premature eviction from the memory 204. In addition to runtime resources and configuration parameters, the receiving module 210 is configured to parse environment-specific data blocks. These blocks include camera calibration matrices, lens distortion coefficients, ambient lighting presets, color correction parameters, and initialization parameters for surface detection. The receiving module 210 extracts and formats the environment-specific parameters in a standardized schema for downstream consumption by the integration module 218. These parameters are essential for accurate alignment of virtual objects within the physical environment, enabling contextual consistency and spatial coherence during the MR session.

In one embodiment, the receiving module 210 implements a staged prefetching

strategy, where low-priority or anticipatory assets are fetched asynchronously after core assets are loaded. In another embodiment, the receiving module 210 includes a decompression engine capable of unpacking compressed or encrypted asset bundles before storage into memory 204. In further embodiments, the receiving module 210 applies adaptive bandwidth management policies, optimizing asset download sequences based on observed network latency and throughput metrics, thereby ensuring uninterrupted MR experience initiation.

As described herein, the activation module 212 is configured to initiate execution of the modular mixed reality engine 108. The execution is done after successful reception of decoded metadata and retrieval of associated runtime resources by the receiving module 210. The activation module 212 provisions a secure and sandboxed runtime environment designed to isolate the execution of the mixed reality experience from other applications or processes operating on the user device 104. The sandboxed environment created by the activation module 212 is instantiated in accordance with platform-level security policies. These policies include container-level isolation, restricted memory access, and runtime permission gating.

The activation module 212 further initiates a hardware capability provisioning sequence where the activation module 212 requests and validates access to one or more hardware subsystems of the user device 104. The hardware subsystems include image acquisition units, gyroscopic sensors, inertial accelerometers, magnetometers, microphones, depth cameras, and location services. The activation module 212 interfaces with system-level permission managers and user interface policy controllers to ensure that the required access rights are explicitly granted before engine launch. Upon confirmation of required hardware permissions, the activation module 212 initializes the runtime engine shell associated with the modular mixed reality engine 108. Initialization includes setting up environment variables, establishing execution thread priorities, configuring input-output communication pipes, and activating low-level sensor data acquisition threads.

The activation module 212 is further configured to instantiate a dependency management component within the modular mixed reality engine 108. The dependency management component is responsible for registering available modules, resolving runtime module dependencies, validating module manifest integrity, and configuring inter-module communication channels. The dependency management component also maintains a directed acyclic graph (DAG) representing functional interdependencies between selected MR modules. The dependency management component signals execution readiness only after all critical dependencies are resolved and memory allocations are confirmed.

In parallel with engine initialization, the activation module 212 performs a pre-execution diagnostic analysis of device state parameters. The activation module 212 queries operating system APIs and device telemetry interfaces to acquire metrics. The metrics include current central processing unit (CPU) load, graphics processing unit (GPU) utilization, available random-access memory (RAM), battery charge status, active background processes, thermal condition indicators, and current network connectivity state. The acquired device metrics are evaluated using a predefined policy map stored in memory 204, and a contextual execution profile is determined.

Based on the diagnostic evaluation, the activation module 212 selects and configures an appropriate execution mode for the modular mixed reality engine 108. In one embodiment, when the user device 104 is in a high-performance state with adequate battery reserves, stable network connectivity, and low thermal load, the activation module 212 selects a full-feature execution mode. The full-feature execution mode enables computationally intensive modules such as volumetric hologram rendering, real-time ambient occlusion, persistent anchor caching, and high-definition gesture mapping. In another embodiment, when the device is operating under constrained conditions, such as low battery state, high CPU utilization, or elevated thermal profile, the activation module 212 configures a lightweight execution mode. The lightweight mode selectively disables resource-intensive modules and enables fallback modules optimized for reduced power consumption, such as flat overlay rendering, simplified object tracking, and static anchor positioning.

In an exemplary use-case consistent with the present disclosure, the activation module 212 is invoked when a user interacts with a hyperlink trigger corresponding to a virtual product try-on experience for an eyewear brand. Upon metadata reception, the activation module 212 provisions a secure container, requests access to the front-facing camera and gyroscope and initiates a lightweight execution mode in response to observed low network bandwidth. The activation module 212 signals the modular mixed reality engine 108 thereafter to initiate loading gesture-tracking and image overlay modules required for aligning virtual eyewear frames to the user's face in real time.

In a further embodiment, the activation module 212 supports dynamic re-evaluation of the execution mode during runtime. The re-evaluation allows real-time adaptation of module configurations if the device state parameters deviate significantly from the original initialization condition. The aforementioned permits dynamic feature activation within the modular mixed reality engine 108 without requiring session termination. The modular mixed reality engine 108 includes a runtime framework configured to execute mixed reality applications in a modular and resource-optimized manner. The modular mixed reality engine 108 includes service abstractions for graphics rendering, audio playback, spatial localization, and real-time sensor integration. The modular mixed reality engine 108 maintains isolation boundaries between dynamically loaded MR modules and is capable of executing modules independently using a manifest-based architecture. Each MR module is registered with the modular mixed reality engine 108 via a manifest file. The manifest file includes input and output specifications, dependency declarations, lifecycle handlers, and version constraints. The modular mixed reality engine 108 is further configured to execute within a web assembly runtime, a native mobile execution context, or a browser sandbox, depending on the user device 104.

The dynamic module orchestrator 214 is configured to manage the full lifecycle of the plurality of mixed reality (MR) modules 110. The lifecycle includes selection, dynamic runtime loading, execution state management, inter-module dependency coordination, and prioritization of computational resources. In addition, the lifecycle include unloading of non-essential modules based on real-time performance constraints. The dynamic module orchestrator 214 is configured to evaluate a plurality of contextual parameters associated with the user environment, device state, and MR session metadata. Accordingly, the dynamic module orchestrator 214 selects one or more compatible MR modules from among the plurality of mixed reality (MR) modules 110 for execution within the modular mixed reality engine 108.

In an embodiment, the contextual parameters include real-time physical environment characteristics sensed through the user device 104. The physical characteristics include object proximity determined by depth sensing, lighting conditions estimated using camera exposure feedback and color histograms. In addition, the physical characteristics include spatial layout inferred from SLAM-generated meshes, and user orientation derived from gyroscopic measurements. The dynamic module orchestrator 214 also evaluates intrinsic device capabilities. The device capabilities include availability and resolution of imaging sensors, support for depth sensing or LiDAR functionality, pixel density and refresh rate of the display unit and thermal headroom. In addition, the device capabilities include battery level, and availability of parallel computation threads on the CPU and GPU.

In addition to environmental and device constraints, the dynamic module orchestrator 214 further considers session-specific indicators. The session-specific indicators include inferred user intent, interaction history, temporal usage patterns, and content affinity metrics. For example, if the session metadata indicates a product visualization experience for consumer electronics, and prior user activity logs demonstrate repeated engagement with similar modules, the dynamic module orchestrator 214 prioritizes modules associated with high-fidelity rendering of electronic goods. The dynamic module orchestrator 214 also incorporates logic for filtering out incompatible modules whose resource requirements or input modality constraints exceed the current device operating profile.

Upon evaluation, the dynamic module orchestrator 214 retrieves a ranked list of compatible MR modules. Each MR module is annotated with a confidence score and a compatibility descriptor and organizes them into an execution queue prioritized by contextual relevance and predicted performance efficiency. In an exemplary embodiment, if a user scans a QR code on a kitchen appliance, and the lighting conditions indicate a dim indoor environment, the dynamic module orchestrator 214 selects an ambient-light-compensated module configured to overlay a virtual instruction panel onto the appliance surface with enhanced contrast and font scaling.

In another embodiment, if the user device 104 detects motion indicating a walking user, the dynamic module orchestrator 214 may select motion-tolerant MR modules that utilize horizon stabilization and large anchor tolerances to maintain stable content overlays. The dynamic module orchestrator 214 may include logic for continuous re-evaluation of the contextual parameters during session execution. The dynamic module orchestrator 214 enables dynamic switching of modules when user context or device state changes significantly.

The dynamic module orchestrator 214 is configured to load the MR modules for execution. The dynamic module orchestrator 214 is responsible for dynamic allocation of system memory. The dynamic allocation includes assigning heap and stack regions based on the runtime footprint of each MR module. The dynamic module orchestrator 214 resolves inter-module dependencies. The inter-module dependencies include shared resource access, input/output interfaces, animation state controllers, and data transformation pipelines. The dynamic module orchestrator 214 parses manifest file of each module and constructs a dependency resolution graph.

The dynamic module orchestrator 214 initializes module-specific runtime components such as event handlers, input listeners, spatial tracking filters, and object lifecycle controllers. Each initialized module is registered with the modular mixed reality engine 108 using a secure handshake protocol and execution state validation. The dynamic module orchestrator 214 verifies the integrity of each MR module prior to execution. The verification is done by checking digital signatures, hash-based message authentication codes (HMACs), or checksums embedded in the module package. The verification process ensures that the module code has not been tampered with or corrupted.

In some embodiments, the dynamic module orchestrator 214 is configured to prefetch one or more anticipated MR modules based on predictive modelling of user interaction trajectories. The dynamic module orchestrator 214 may include an inference engine trained on historical user navigation patterns and session transition probabilities, which determines the likelihood of subsequent module requirements. For example, in an augmented shopping experience, if the user has just interacted with a virtual shoe try-on module, the dynamic module orchestrator 214 may prefetch apparel or accessory modules that are frequently used in conjunction with footwear in similar sessions, reducing latency during content switching.

In another embodiment, when operating under constrained network conditions, the dynamic module orchestrator 214 may include logic to load a placeholder lightweight module while queuing full-featured modules for background download. In yet another embodiment, the dynamic module orchestrator 214 may include mechanisms to prioritize module loading based on rendering pipeline bottlenecks. The dynamic module orchestrator 214 ensures that modules with high impact on frame rate or latency are deferred or substituted with lower fidelity variants.

The dynamic module orchestrator 214 may include a feedback loop. The feedback loop is provided between the dynamic module orchestrator 214 and the modular mixed reality engine 108 to dynamically unload inactive modules. The dynamic unloading is performed when memory thresholds are breached or when changes in user context render specific modules irrelevant. The unloading process includes state serialization, memory deallocation, and clean detachment from rendering and input subsystems. This preserves system stability and maintaining interactive performance

In some embodiments, the rendering module 216 is configured to generate and deliver a context-aware mixed reality (MR) experience. The mixed reality (MR) experience is delivered by compositing one or more virtual assets onto the physical environment as captured through a real-time camera feed of the user device 104. The rendering module 216 receives spatial alignment data, object placement coordinates, and visual parameters from the integration module 218 and the modular mixed reality engine 108. Accordingly, the rendering module 216 constructs a composite visual scene that blends digital content seamlessly into the physical environment. The rendering module 216 performs a plurality of transformation operations. The plurality of transformation operations include three-dimensional coordinate mapping, viewport calibration, camera pose correction, and projection matrix generation. The plurality of transformation operations enable accurate alignment of rendered virtual objects within the spatial coordinate system defined by the real-world environment.

The rendering module 216 manages the rendering pipeline for both static and dynamic virtual elements, including texture mapping, material blending, transparency handling, and motion interpolation. Texture atlases and material libraries retrieved by the receiving module 210 are loaded and applied to three-dimensional models through UV unwrapping and mipmap scaling. The rendering module 216 also orchestrates animation playback through management of animation timelines, keyframe interpolation, skeletal rig control, and physics-driven motion synthesis. In one embodiment, a digital human avatar is rendered to walk across a real floor surface with footstep synchronization and animation blending to maintain realism.

The rendering module 216 incorporates graphical optimization techniques. The optimization techniques include level-of-detail (LOD) management, occlusion culling, object pooling, and draw-call reduction to minimize rendering latency and conserve device resources. The rendering module 216 further utilizes GPU acceleration available on the user device 104 to offload computationally intensive graphics operations including vertex shading, fragment processing, and post-processing effects. In another embodiment, the rendering module 216 may include adaptive resolution rendering logic that dynamically adjusts frame resolution based on GPU temperature, battery state, and network latency, enabling continuous frame rate stability.

The rendering module 216 supports a wide range of virtual media formats. The virtual media formats include three-dimensional holographic models, two-dimensional and three-dimensional video overlays, image annotations, and procedurally generated content layers. Alpha channel video overlays are rendered using chroma blending and depth-aware occlusion masking, enabling translucent digital elements to appear embedded within the physical space. For example, a floating instructional hologram rendered above a product surface includes a transparent animated video with overlaid callouts, generated through alpha blending and anchored using anchor point metadata from the integration module 218.

In one embodiment, the rendering module 216 supports stereoscopic rendering for depth-enhanced experiences using dual-camera input or spatial camera calibration. In another embodiment, the rendering module 216 enables spatial audio feedback synchronized with rendered objects by integrating directionally encoded audio sources and real-time environmental reverberation modeling. Virtual annotations such as labels, guidance arrows, or contextual prompts are rendered as overlay elements that remain fixed relative to anchor coordinates. These elements include automatic scaling and occlusion adaptation to maintain readability and scene coherence under varying viewing angles and lighting conditions.

The rendering module 216 is also configured to support user interface overlays. The overlays include interaction menus, gesture indicators, voice input acknowledgment signals, and progress bars for module loading. The rendering module 216 may further incorporate eye-tracking or gaze estimation features for user-centric rendering prioritization, where areas of focus receive higher rendering fidelity compared to peripheral regions. The rendering module 216 thereby facilitates real-time generation and interactive presentation of highly responsive, spatially aligned, and visually integrated MR content within the adaptive user interface of the user device 104.

The integration module 218 is configured to perform high-precision spatial integration and persistent anchoring of one or more virtual elements within a real-world physical environment, as viewed through the user device 104. The integration module 218 enables accurate and context-aware placement of digital content by leveraging an ensemble of spatial perception algorithms. The algorithms include simultaneous localization and mapping (SLAM), structure-from-motion (SFM), monocular and stereo depth estimation. In addition, the algorithms include infrared or time-of-flight based depth sensing, feature-based scene reconstruction, and multi-plane detection algorithms. The integration module 218 utilizes real-time environmental data acquired from the set of hardware components 104A. The set of hardware components 104A include monocular or stereo cameras, gyroscopes, accelerometers, LiDAR sensors, and ambient light sensors. The integration module 218 generates a dense and semantically rich spatial map of the surrounding physical environment using the environmental data.

The spatial map generated by the integration module 218 includes a set of three-dimensional coordinate frames, surface normal, curvature data, edge contours, feature points, and semantic surface classifications, organized in a globally referenced structure. The spatial map serves as the foundational coordinate space for placement, transformation, and interaction of virtual elements in a manner consistent with the real-world geometry and topology. The integration module 218 computes global and local transformation matrices for each tracked region or feature cluster in the spatial map. This ensures that all digital content remains geometrically aligned with the real-world surfaces under dynamic camera motion, user interaction, and environmental changes.

The integration module 218 is further configured to identify and assign persistent anchor points to detected surfaces and environmental features. Anchor points serve as fixed spatial references that are continuously updated using feature stability scores, visual-inertial tracking consistency, and surface deformation metrics. The anchor point assignment process is driven by a set of heuristics that prioritize planar, rigid, and photometrically stable surfaces such as walls, floors, tables, or furniture tops. In one embodiment, a virtual object such as a 3D appliance model is anchored to a floor surface with scale and orientation adjusted automatically based on anchor pose metadata and gravitational alignment. The integration module 218 monitors device motion and camera reorientation and performs anchor position recalibration using error minimization techniques. The minimization techniques include Kalman filtering, least-squares matching, or bundle adjustment algorithms.

The integration module 218 is further configured to compute spatial alignment matrices for each virtual element. The alignment matrices include position, rotation, and scale transformations with respect to the detected anchor coordinate frames. The integration module 218 applies constraints derived from environmental physics such as gravity alignment, collision bounds, and line-of-sight visibility to ensure photorealistic placement of virtual content. For example, a virtual book rendered on a desk remains visually level with the surface and does not penetrate or float above it due to computed surface normal and contact resolution constraints. In an alternative embodiment, a virtual avatar is constrained to walk along a tracked corridor path, adapting its gait based on environment geometry and avoiding obstacles detected by the SLAM engine.

The integration module 218 includes an occlusion modelling subsystem configured to enable partial or full visual occlusion of rendered virtual elements based on detected real-world geometry and depth layering. The occlusion subsystem utilizes depth maps computed from stereo disparity, infrared projections, or machine learning-based monocular depth inference to generate pixel-wise occlusion masks. The aforementioned occlusion masks are used to selectively suppress rendering of virtual object fragments that fall behind real-world surfaces, producing a visually consistent mixed reality composition. In one embodiment, a virtual pet rendered behind a sofa remains partially hidden when the user moves around the scene, enhancing realism and depth perception.

The integration module 218 is also configured to enable real-time interactivity between virtual and physical entities based on proximity analysis, collision detection, and simulated physical responses. The integration module 218 includes a contact modelling component that detects overlaps between digital object bounding volumes and physical object estimates derived from the spatial map. Upon detecting proximity events, the integration module 218 may apply simulated physical forces such as bounce, slide, snap, or deformation. In one embodiment, a virtual ball thrown toward a wall is rendered to bounce back with velocity and spin derived from surface stiffness coefficients and impact angles computed from wall pose metadata. In another embodiment, a virtual button placed on a table is rendered to depress in response to user finger motion detected using depth sensing.

The integration module 218 may include logic to support adaptive spatial remapping. The spatial remapping involves anchor point assignments and recalculation of object placements when dynamic environmental changes are detected. Examples of the environmental changes include object movement, user relocation, or change in lighting conditions. The integration module 218 may preserve historical anchor trajectories to ensure temporal persistence of virtual objects even during temporary occlusion or sensor dropout. In a further embodiment, the integration module 218 may be configured to correlate the SLAM-generated spatial map with a predefined semantic layout model of a known physical environment. The semantic layout model may be retrieved based on location services or QR code metadata and includes labelled regions such as kitchen, living room, workstation, or showroom display area. The integration module 218 performs layout correlation using feature signature matching, object contour alignment, or room shape similarity scoring. Upon successful correlation, the integration module 218 enables environment-sensitive virtual content placement. Example of this includes placing a virtual recipe assistant near a kitchen counter, an instructional hologram near a workstation, or promotional signage above a storefront.

In an additional embodiment, the integration module 218 may support multi-user spatial synchronization, where anchor maps are shared across devices in a collaborative session. This enables consistent positioning of shared virtual elements regardless of the viewing perspective. Anchor state updates may be propagated over a low-latency network link and reconciled using consensus models or server-verified anchor reference databases.

The system 106 dynamically adjust the mixed reality (MR) experience based on real-time physical environment data, real-time spatial analysis, and the hardware and software configuration of the user device 104. The system 106 continuously receives physical environment data from onboard sensors such as RGB cameras, LiDAR scanners, and depth sensors integrated into the user device 104. This data is processed to detect spatial characteristics such as walls, surfaces, furniture, lighting conditions, and occlusions within the user's surroundings.

The system 106 further interfaces with spatial analysis algorithms to generate a real-time 3D map of the environment. The spatial map identifies geometric and semantic features, including boundaries, surface orientations, object positions, and spatial constraints. Concurrently, the system 106 evaluates the hardware and software configuration of the user device 104. The hardware and software configuration includes parameters such as processor load, memory availability, battery state, network conditions, and graphical processing capabilities. Based on these inputs, the system 106 adaptively modifies the visual, spatial, and behavioral properties of one or more virtual elements. For example, in environments with poor lighting, the rendering module adjusts the brightness and shading of rendered objects to enhance visibility. On lower-specification devices, it may reduce polygon counts, downscale texture resolutions, or limit the number of simultaneously rendered objects. In contrast, higher-performance devices may enable enhanced effects such as real-time shadows, reflections, depth-of-field rendering, or physically based lighting

The adaptive rendering capability ensures that digital elements such as 3D furniture, holographic avatars, or animated overlays remain spatially aligned with the physical environment. The adaptive rendering enables delivery of a coherent, immersive, and resource-optimized MR experience tailored to the device and context.

The system 106 is configured to dynamically adjust the mixed reality (MR) experience both prior to rendering and during the rendering process. The system 106 receives continuous input from onboard sensors such as RGB cameras, depth sensors, LiDAR scanners, accelerometers, and gyroscopes, capturing the geometric and semantic characteristics of the physical environment. These inputs are processed through spatial analysis algorithms to generate a spatial map that includes information about surfaces, boundaries, object positions, and environmental lighting conditions.

Before initiating rendering, the system 106 uses the spatial map and contextual parameters to determine how virtual elements should be placed, oriented, scaled, or anchored within the environment. The system 106 also assesses device-specific parameters such as CPU/GPU availability, battery level, network bandwidth, and operating system constraints to decide the level of detail, resolution, and rendering fidelity suitable for the session.

During the rendering process, the system 106 continues to monitor real-time changes in environmental conditions (e.g., user movement, occlusion, or lighting variation) and system performance metrics. Based on this continuous input, the system 106 adaptively modifies aspects of the MR experience. The aspects include the quality of textures, the level of animation, the inclusion of visual effects, or the use of fallback rendering modes, to ensure that virtual elements remain perceptually coherent, spatially aligned, and responsive to the user's context. This dynamic adjustment process applied both before and during rendering, enables a fluid and immersive MR experience tailored to the evolving physical and computational conditions of the user device 104.

Each of the components and modules described in FIG. 2 collectively contribute to execution of a secure, dynamic, and context-aware mixed reality experience, without requiring prior installation of the application. The components and modules enable device-agnostic rendering, real-time interaction, and persistent virtual content integration.

In an embodiment of the present disclosure, the system 106 employs an adaptive data streaming protocol that adjusts streaming quality and rate based on network conditions. The system 106 utilizes adaptive bitrate streaming to ensure minimal latency for alpha channel videos and 3D models. Key details include network monitoring, which involves real-time bandwidth and latency measurement; quality adjustment, dynamically adjusting asset quality; and buffering strategies that use caching to prevent interruptions. For example, during a network slowdown, the system reduces the quality of streamed assets to maintain a smooth experience. The integration of edge computing allows computationally intensive tasks to be offloaded to the user's edge device or mobile device, reducing device load and latency and enhancing performance. For instance, complex physics simulations for an MR training app can be processed on edge devices or locally on a phone, with results streamed to the user's device.

In an embodiment, the user interaction and feedback system features an adaptive user interface framework that dynamically adjusts based on user interactions and environmental factors, providing an intuitive and immersive experience. In an embodiment, features include a responsive design for different devices, contextual controls appearing when relevant, and support for touch, gestures, and voice input. For example, in a navigation app, UI elements adjust based on whether the user is walking or driving. Additionally, haptic feedback integration enhances immersion by providing tactile responses, such as vibrations or force feedback. In an MR shopping app, when a user selects a virtual product, a vibration simulates the sensation of picking up an item.

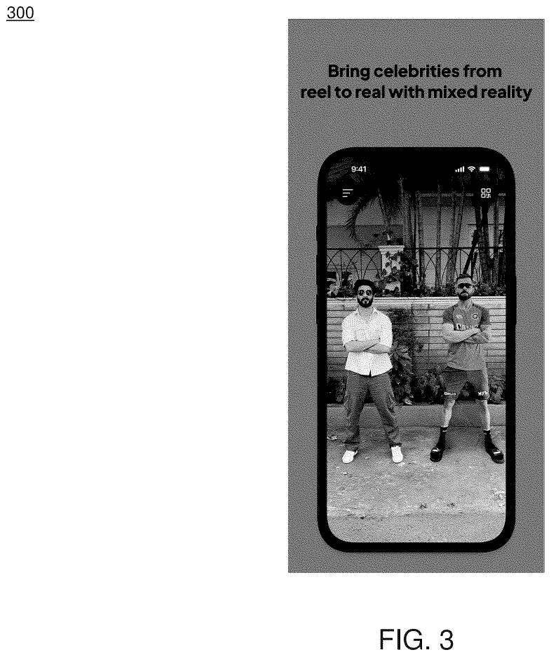

FIG. 3 illustrates a screenshot 300 of an exemplary instant application interface 302 showing a co-created mixed reality content 304, in accordance with an embodiment of the present disclosure. The mixed reality content 304 is rendered within a mixed reality environment. Specifically, the rendered mixed reality content 304 depicts a real user (e.g., a person on the left) co-present with a virtual avatar (e.g., a virtual representation of a celebrity on the right). The virtual avatar is seamlessly integrated into the real-world background, demonstrating sophisticated spatial alignment and contextual appropriateness. The digital object (the virtual avatar) is scaled, positioned, and oriented such that it appears to convincingly occupy the same physical space as the real user and the surrounding real-world environment. This enhances the realism and immersive quality of the mixed reality experience. The co-creation aspect is evident in how the virtual avatar is dynamically placed and aligned in relation to the real person, suggesting a user-driven interaction in shaping the composite scene.

The co-created mixed reality content 304 demonstrates an ability of the system 106 to seamlessly integrate virtual assets into the physical environment. The system 106 ensures realistic appearance, contextual relevance, and spatial alignment with the real world as viewed through an exemplary handheld device 306. The mixed reality content 304 is displayed on a screen of the handheld device 306. The application interface 302 corresponds to a dynamic interface of an instant application rendering the mixed reality content 304 on the handheld device 306.

The co-creation of the mixed reality content 304 by a user is enabled through real-time interaction. When a user views a mixed reality content, the system 106 enables the user to actively participate in content creation by utilizing mixed reality assets and the rendering capability provided by the system 106. Here, cameras of the handheld device 306, in conjunction with other sensors, assist the system 106 in understanding the physical environment and detecting available surfaces.

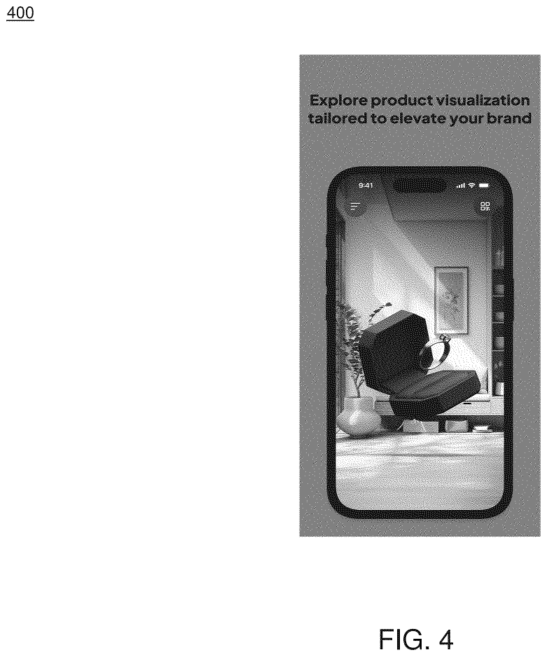

FIG. 4 illustrates another screenshot 400 of an exemplary instant application interface 402 showing another mixed reality content 404, in accordance with an embodiment of the present disclosure. Specifically, the rendered mixed reality content 404 depicts product visualization of a brand. The mixed reality content 404 is rendered within a mixed reality environment. The rendered mixed reality content 404 shows product visualization of a brand in a mixed realty ecosystem. The mixed reality content 404 is displayed on a screen of an exemplary handheld device 406. The application interface 402 corresponds to a dynamic interface of an instant application running or executing the mixed reality experience on the handheld device 406.

As shown in FIG. 4, the product visualization is exemplified by a virtual jewelry box and ring 408 (visible within the instant application interface 402) seamlessly integrated into a physical room environment around the handheld device 406. The visualization enables users to remotely preview digital representations of products, such as the virtual jewelry 408, within their real-world surroundings. In an embodiment, the mixed reality content 404 depicts an application of the system 106 for advertising and marketing for brands. In an example, the instant application experience on the handheld device 406 can be initiated by scanning a Quick Response (QR) code configured for triggering the mixed reality content experience.

The physical environment depicted in the screenshot 400 illustrates an indoor setting, appearing to be a room within a dwelling or commercial space. The physical environment includes various real-world features such as walls, a floor, and existing furniture (e.g., a bench or couch, a plant, and a framed picture). The system 106 utilizes data from the sensors (e.g., cameras, depth sensors, gyroscope) of the handheld device 406. The sensor data helps the system 106 to detect and analyze various features of the physical environment, including planar surfaces (e.g., floors, walls, tabletops) for accurate virtual object placement, and spatial geometry and dimensions of the room to facilitate appropriate scaling and positioning. Furthermore, the system 106 detects feature points in the environment for robust positional tracking of the handheld device 406. This enables the virtual content to remain spatially anchored and coherent with the user's movement within the real world.

In an embodiment, the product visualization within the MR content 404, such as the virtual jewelry 408, is dynamically positioned and scaled within the physical environment. This ensures realistic appearance, accurate spatial alignment, and contextual appropriateness. The system 106 leverages environmental data to detect surfaces, understand the spatial context of the user's real-world environment, and integrate the virtual product (e.g., the jewelry box and ring).

The system 106 enables the user to actively manipulate the digital objects within the mixed reality environment, such as the virtual jewelry 408 shown in the MR content 404. A user can dynamically adjust various features of the digital object to suit their preferences or the specific context of their physical environment through real-time interaction via the handheld device 406. In an example, scaling the jewelry to fit a desired visual proportion. In another example, moving the jewelry box to a different part of the room. In yet another example, rotating the ring to view it from various angles. In yet another example, replacing the digital object by swapping one ring design for another or changing its texture, material, or visual properties (altering the finish of the jewelry from matte to polished). This interactive manipulation capability empowers the user to personalize their mixed reality experience, enhancing the utility for applications like product visualization and virtual try-on.

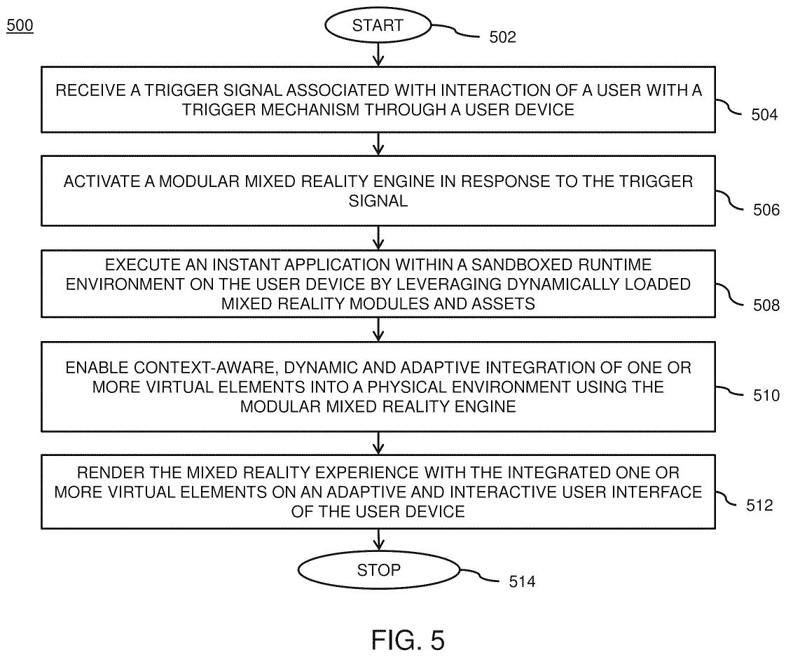

FIG. 5 illustrates a flow chart of a method 500 for executing the dynamic mixed reality experience on a user device 104, in accordance with various embodiments of the present disclosure. The method 500 enables the rendering of the mixed reality content at the user device 104. In addition, the method 500 executes a dynamic and adaptive workflow for the mixed reality experience. It may be noted that the description of the flowchart 500 refers to FIG. 1 and FIG. 2. The working and functioning may be read from the description of FIG. 1 and FIG. 2.

The method 500 executes a dynamic and adaptive workflow for the mixed reality experience. It may be noted that the description of the flowchart 500 refers to FIG. 1 and FIG. 2. The working and functioning may be read from the description of FIG. 1 and FIG. 2.

The dynamic and adaptive workflow of method 500 is characterized by its ability to adjust its execution path and resource utilization in real-time based on various parameters. This adaptive nature allows the method to efficiently manage the demanding computational requirements of rendering mixed reality content while optimizing user experience. The workflow dynamically responds to factors such as user input, changes in the physical environment (as detected by sensors), available computational resources on the user device 104, and the specific mixed reality content or experience being delivered.

For instance, the workflow may dynamically load or unload specific mixed reality modules and assets based on the user's current interaction or the evolving context of the mixed reality scene. This ensures that only the necessary components are active, thereby conserving processing power and memory. Furthermore, the workflow can adapt by modifying rendering parameters (e.g., level of detail, frame rate) or prioritizing certain processing tasks in response to fluctuations in device performance or network conditions, maintaining a fluid and coherent mixed reality experience. This dynamic adaptability contrasts with static, pre-defined workflows, allowing the method 500 to provide a seamless and responsive mixed reality experience across varying conditions.

The flowchart 500 initiates at step 502. At step 504, the method includes receiving the trigger signal associated with interaction of the user with the trigger mechanism through the user device 104. The trigger mechanism includes a device-agnostic universal access link configured to invoke an instant application on the user device 104 without requiring installation. The universal access link is associated with each of the plurality of triggering actions. The plurality of triggering actions includes but may not be limited to scanning a QR code, clicking a hyperlink, detecting a near field communication (NFC) tag, receiving a voice command, or recognizing a gesture input. In an embodiment of the present disclosure, the QR code may be captured through one or more cameras of the user device 104, decoded, and utilized to extract metadata required for initializing the modular MR engine 108.

At step 506, the method includes activating the modular mixed reality engine 108 configured to dynamically load the plurality of mixed reality modules 110 and assets. The modular mixed reality engine 108 includes the plurality of mixed reality (MR) modules 110. The modular mixed reality (MR) engine 108 enables the cross-module communication between the plurality of mixed reality (MR) modules 110.

At step 508, the method includes executing the instant application within the sandboxed runtime environment on the user device 104 by leveraging the dynamically loaded mixed reality modules and assets. The sandboxed runtime environment is deployed on the user device 104. In an embodiment, the sandboxed runtime environment includes the instant application mechanism. The instant application mechanism includes temporarily deploying an instant application on the user device 104. In an embodiment, the instant application has a size of less than 10 Megabytes. In another embodiment of the present disclosure, the instant application has a pre-defined size ranging from 900 kilobytes to 1.2 megabytes. In yet another embodiment, the size of the instant application varies based on the modules and assets required for executing a particular mixed reality experience.

At step 510, the method includes enabling, using the modular mixed reality engine 108, context-aware, dynamic and adaptive integration of the one or more virtual elements into the physical environment displayed through the user interface of the user device 104. The integration is performed based on real-time physical environment data and real-time spatial analysis of the physical environment. In an embodiment of the present disclosure, the method enables dynamic loading of one or more mixed reality modules with facilitation of the dynamic module orchestrator 214. The dynamic module orchestrator 214 dynamically loads the mixed reality (MR) modules in real-time based on context inferred from the user input and environmental data, with modules operating within the kernel-level application sandbox in the Linux-based system to ensure both performance and security.

At step 512, the method includes rendering the mixed reality experience with the integrated one or more virtual elements on the adaptive and interactive user interface of the user device 104. The rendering enables dynamic digital placement, manipulation, and transformation of the one or more virtual elements. The rendered mixed reality experience is dynamically adjusted based on the real-time physical environment data, the real-time spatial analysis and a hardware and software configuration of the user device 104.

The dynamic adjustment in real time means that the system 106 executes a method step to continuously senses and processes the user's surrounding environment through onboard sensors to obtain updated physical environment data. The sensors include cameras, LiDAR scanners, and depth sensors. The environment data includes structural elements like walls, floors, furniture, and other objects in the environment. Using computer vision and spatial mapping algorithms, the system 106 executes a method step to perform spatial analysis to generate a 3D representation of the environment, identifying surfaces, boundaries, depth relationships, and potential occlusions.

Simultaneously, the system 106 executes a method step to evaluate the hardware and software configuration of the user device 104. The hardware and software configuration include parameters such as CPU and GPU capabilities, memory availability, battery state, thermal condition, and operating system constraints. Based on these insights, the modular mixed reality engine 108 executes a method step to optimize the MR experience by adjusting the quality, behavior, and rendering of digital content.

For instance, if the system 106 detects a low-light environment, it may adjust the lighting parameters of virtual elements to maintain visibility. In another example, if the device has limited processing power, the engine 108 may reduce texture resolution, limit the number of active digital objects, or defer complex rendering tasks to edge servers. Conversely, on a high-end device with ample resources, the experience may include more detailed 3D models, realistic shadows, dynamic reflections, and interactive holograms that react to user gestures or speech. As a result, a user viewing a virtual lamp on a table through their phone may see the object respond not only to their physical movements and inputs but also adapt in form or quality depending on whether they're using a basic smartphone or a premium MR headset, ensuring both consistency and performance across devices and environments.

The system 106 executes a method step to dynamically adjust the mixed reality (MR) experience both prior to rendering and during the rendering process. The system 106 executes a method step to receive continuous input from onboard sensors such as RGB cameras, depth sensors, LiDAR scanners, accelerometers, and gyroscopes, capturing the geometric and semantic characteristics of the physical environment. These inputs are processed through spatial analysis algorithms to generate a spatial map that includes information about surfaces, boundaries, object positions, and environmental lighting conditions.

Before initiating rendering, the system 106 executes a method step to use the spatial map and contextual parameters to determine how virtual elements should be placed, oriented, scaled, or anchored within the environment. The system 106 executes a method step to assess device-specific parameters such as CPU/GPU availability, battery level, network bandwidth, and operating system constraints to decide the level of detail, resolution, and rendering fidelity suitable for the session.

During the rendering process, the system 106 executes a method step to continuously monitor real-time changes in environmental conditions (e.g., user movement, occlusion, or lighting variation) and system performance metrics. Based on this continuous input, the system 106 executes a method step to adaptively modify aspects of the MR experience. The aspects include the quality of textures, the level of animation, the inclusion of visual effects, or the use of fallback rendering modes, to ensure that virtual elements remain perceptually coherent, spatially aligned, and responsive to the user's context. This dynamic adjustment process applied both before and during rendering, enables a fluid and immersive MR experience tailored to the evolving physical and computational conditions of the user device 104.

Rendering the MR content includes rendering at least one digital object within the physical environment on a display of the user device 104 based on the spatial map. The digital object is visually aligned with a real-time camera view captured by the camera module of the user device 104. The method enables seamless playback of the rendered mixed reality content on the user device 104. The seamless playback is enabled through a continuous optimization of resource utilization of the user device 104.

In an embodiment, the method includes extracting the metadata embedded in the detected triggering action for determining at least a mixed reality content associated with the detected triggering action. In an embodiment, the method includes deploying, in response to the extraction, a mixed reality bundle on the user device 104. The mixed reality bundle includes the plurality of mixed reality modules 110.

In an embodiment, the method includes dynamically loading and orchestrating the plurality of mixed reality modules 110. Further, the method includes enabling, using the modular mixed reality engine 108, context-aware and dynamic integration of the one or more virtual elements into the physical environment. The physical environment is displayed through a user interface of the user device 104.

In an embodiment, the integration is done based on a real time physical environment data fetched from the set of hardware components 104A of the user device 104.

In an embodiment of the present disclosure, the one or more virtual elements include at least one digital object positioned into the physical environment. The integration includes capturing the physical environment data from the set of hardware components, applying one or more computer vision algorithms on the physical environment data for performing the real-time spatial analysis of the physical environment, generating a spatial map of the physical environment based on the real-time spatial analysis, and determining one or more positions for placing the at least one digital object within the physical environment based on the spatial map and one or more contextual parameters.

In an embodiment of the present disclosure, the digital placement, manipulation and transformation of the one or more virtual elements includes at least changing a current position of the at least one digital object, altering a size of the at least one digital object, rotating the at least one digital object, changing a texture of at the least one object, and replace the at least one digital object.

In an embodiment of the present disclosure, the mixed reality bundle includes one or more libraries configured for at least one of ground tracking, light estimation, alpha channel video rendering, image rendering, video rendering, three-dimensional object rendering and instant environment detection.

In an embodiment of the present disclosure, the method further includes enabling, by a digital distribution provider, an instant, on-demand mixed reality experience on the user device 104. The mixed reality experience is enabled without requiring the full application download or redirection to an application storage database. The mixed reality experience is enabled by intercepting a request to access the universal access link initiated by the user interaction. Subsequently, in response to the interception and user approval through a user interface prompt, the modular mixed reality engine 108 is activated.

In an embodiment of the present disclosure, the trigger mechanism includes an embedded metadata. The embedded metadata includes at least one of a mixed reality (MR) experience identifier, asset locations, and one or more parameters controlling the mixed reality (MR) experience.

In an embodiment of the present disclosure, the integrated one or more virtual elements includes at least one digital object placed into the physical environment. The integration includes capturing the physical environment data from the set of hardware components 104A. Next, the integration includes applying one or more computer vision algorithms on the physical environment data for performing the real-time spatial analysis of the physical environment. Next, the integration includes generating a spatial map of the physical environment based on the real-time spatial analysis. The spatial map represents at least one of one or more surfaces, one or more objects, one or more boundaries, and one or more reference points. Lastly, the integration includes determining one or more positions for placing the at least one digital object within the physical environment based on the spatial map and one or more contextual parameters. The one or more contextual parameters include at least a type of object, a type of environment, spatial constraints in the physical environment, device state and a derived user intent for accessing the mixed reality experience.

In an embodiment of the present disclosure, the integration of the at least one digital object includes anchoring the at least one digital object on the one or more surfaces or the one or more objects in the physical environment. The at least one digital object is integrated persistently within the physical environment such that spatial position and orientation of the at least one digital object is aligned with the physical environment.

In an embodiment of the present disclosure, the digital placement, manipulation and transformation of the one or more virtual elements includes at least changing a current position of the at least one digital object, altering a size of the at least one digital object, rotating the at least one digital object, changing a texture of at the least one object, and replace the at least one digital object.

In an embodiment of the present disclosure, the secure execution framework is configured to deploy the mixed reality bundle in the sandboxed runtime environment without requiring prior installation of an application on the user device 104.

In an embodiment of the present disclosure, the trigger mechanism enables initiating a device-agnostic and a platform-agnostic mixed reality (MR) experience. The trigger mechanism includes at least one of scanning of a quick response (QR) code through a camera of the user device 104, clicking on a hyperlink received on the user device 104, detection of a near field communication (NFC) tag through the user device 104, reception of a voice input through the user device 104, and recognition of a gesture input provided by the user.

In an embodiment of the present disclosure, the mixed reality bundle includes one or more libraries configured for at least one of ground tracking, light estimation, alpha channel video rendering, image rendering, video rendering, three-dimensional object rendering and instant environment detection.

In an embodiment of the present disclosure, the set of hardware components 104A includes at least one of one or more cameras, a depth sensor, a LiDAR scanner, an accelerometer, and a gyroscope.

In an embodiment of the present disclosure, the modular mixed reality engine 108 dynamically loads or unloads one or more mixed reality modules based on available system resources and user interaction context. The user interaction context is recognized by continuously monitoring and assessing at least device resource availability based on a plurality of parameters of the user device 104. The plurality of parameters includes at least CPU utilization, GPU utilization, battery state, network conditions, and thermal thresholds. The monitoring and the assessment enables real-time orchestration and optimization of the one or more mixed reality modules.

In an embodiment of the present disclosure, the method and system 106 enable all the native capabilities and hardware of the device 104. The method and system 106 are usable on lower end devices. The method and system 106 provides optimized performance and accessibility for any mixed reality experience. The method and system 106 enable easier distribution of the content. The user can get the best possible experience because the instant application uses native capabilities of the portable user device, and is not restricted by browsers.

In an example application of the invention, the present method and system can be used in advertising industry extensively. Like social media or e commerce platforms have videos embedded for advertising, they can have a URL delivered by the present method and system to view and experience products in mixed reality. In an embodiment of the present disclosure, the URL are shared over messaging platforms which include but not limited to i-message, whatsapp, telegram, internet based chats, sms and the like.

In another example application, the present method and system enables co-creation of content (as depicted in FIG. 3). When a user views mixed reality content, he or she can be a part of content and create new content using the mixed reality assets and the rendering capability provided by the present method and system.

In an embodiment of the present disclosure, the process of placing a digital object involves several coordinated steps, which collectively enable the seamless integration of virtual digital content into a real-world space. Upon user initiation, the system triggers the IAE on a portable communication device, such as a mixed-reality headset, smart glasses, or a mobile device. The device employs an array of sensors, including cameras, depth sensors, LiDAR scanners, accelerometers, and gyroscopes, to capture detailed data of the user's immediate physical environment. The cameras, in particular, play a crucial role in this process by providing high-resolution imagery of the surrounding space, detecting environmental features such as walls, floors, furniture, and objects within the room. The system 106 uses computer vision algorithms to analyze the images captured by the cameras, creating a detailed map of the physical environment in real-time. This mapping allows the system to understand the 3D structure of the space, including the layout and orientation of various surfaces, which serves as a reference frame for positioning and interacting with digital objects. Once the physical environment has been mapped, the system 106 prepares to place a digital object within this space on real time, dynamic and adaptive basis. The digital object, which can be a variety of forms ranging from simple geometric shapes to complex 3D models, holographic entities, avatars, or information overlays, is then ready for placement in the MR space

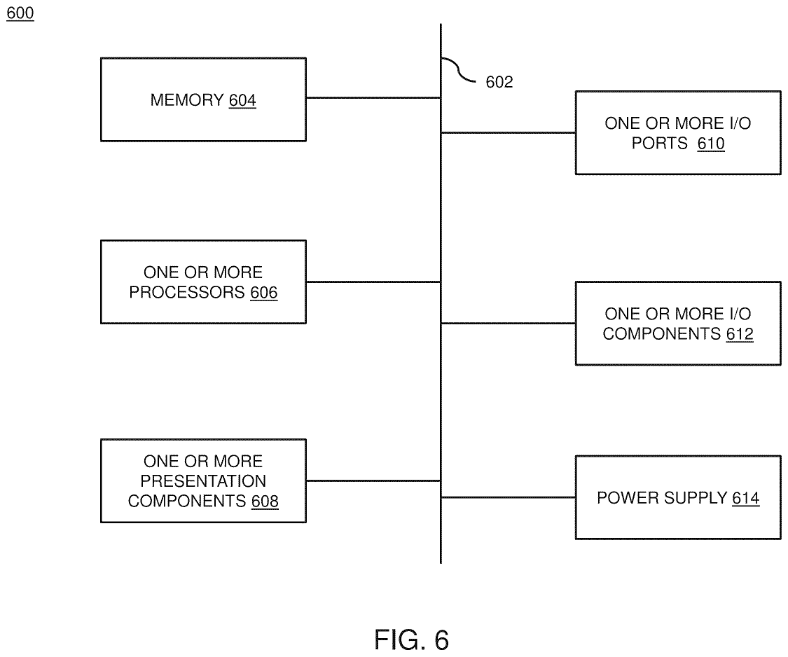

FIG. 6 illustrates a block diagram of an exemplary device 600 configured for executing the dynamic mixed reality experience on the user device 104, in accordance with various embodiments of the present disclosure. The device 600 is configured to render of the mixed reality content. The device 600 is a non-transitory computer-readable storage medium. The device 600 includes a bus 602 that directly or indirectly couples the following devices: memory 604, one or more processors 606, one or more presentation components 608, one or more input/output (I/O) ports 610, one or more input/output components 612, and an illustrative power supply 614. The bus 602 represents what may be one or more buses (such as an address bus, data bus, or combination thereof). Although the various blocks of FIG. 6 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors recognize that such is the nature of the art and reiterate that the diagram of FIG. 6 is merely illustrative of the exemplary device 600 that can be used in connection with one or more embodiments of the present disclosure. Distinction is not made between such categories as “workstation,” “server,” “laptop,” “hand-held device,” etc., as all are contemplated within the scope of FIG. 6 and reference to “device.”

The device 600 typically includes a variety of computer-readable media. The computer-readable media can be any available media that can be accessed by the device 600 and includes both volatile and nonvolatile media, removable and non-removable media. By way of example, and not limitation, the computer-readable media may include computer storage media and communication media. The computer storage media includes volatile and nonvolatile, removable and non-removable media implemented in any method or technology for storage of information such as computer-readable instructions, data structures, program modules or other data. The computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the device 600. The communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 604 includes computer-storage media in the form of volatile and/or nonvolatile memory. The memory 604 may be removable, non-removable, or a combination thereof. Exemplary hardware devices include solid-state memory, hard drives, optical-disc drives, etc. The device 600 includes the one or more processors 606 that read data from various entities such as the memory 604 or the one or more I/O components 612. The one or more presentation components 608 present data indications to a user or other device. Exemplary presentation components include a display device, speaker, printing component, vibrating component, etc. The one or more I/O ports 610 allow the device 600 to be logically coupled to other devices including the one or more I/O components 612, some of which may be built in. Illustrative components include a microphone, joystick, game pad, satellite dish, scanner, printer, wireless device, etc.

The present invention is described hereinafter by various embodiments. This invention may, however, be embodied in many different forms and should not be construed as limited to the embodiment set forth herein. Rather, the embodiment is provided so that this disclosure will be thorough and complete and will fully convey the scope of the invention to those skilled in the art. In the following detailed description, numeric values and ranges are provided for various aspects of the implementations described. These values and ranges are to be treated as examples only, and are not intended to limit the scope of the claims. In addition, a number of system architectures are identified as suitable for various facets of the implementations. These system architectures are to be treated as exemplary and are not intended to limit the scope of the invention.

The foregoing descriptions of specific embodiments of the present technology have been presented for purposes of illustration and description. They are not intended to be exhaustive or to limit the present technology to the precise forms disclosed, and obviously many modifications and variations are possible in light of the above teaching. The embodiments were chosen and described in order to best explain the principles of the present technology and its practical application, to thereby enable others skilled in the art to best utilize the present technology and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present technology.

What is claimed is:

1. A system for executing a dynamic mixed reality experience, the system comprising:
one or more processors; and
a non-transitory memory storing instructions that, when executed by the one or more processors, cause the system to:
receive a trigger signal associated with interaction of a user with a trigger mechanism through a user device, wherein the trigger mechanism comprises a device-agnostic universal access link configured to, upon the user interaction, invoke an instant application on the user device without requiring installation;
in response to the received trigger signal, activate a modular mixed reality engine configured to dynamically load a plurality of mixed reality modules and digital assets;
execute, using a secure execution framework, the instant application within a sandboxed runtime environment on the user device by leveraging the dynamically loaded mixed reality modules and digital assets;
enable, using the modular mixed reality engine, context-aware, dynamic, and adaptive integration of one or more virtual elements into a physical environment displayed through a user interface of the user device, wherein the integration is performed based on real-time physical environment data and real-time spatial analysis of the physical environment; and
render the mixed reality experience with the integrated one or more virtual elements on an adaptive and interactive user interface of the user device, wherein the rendering comprises enabling dynamic digital placement, manipulation, and transformation of the one or more virtual elements, wherein the mixed reality experience is dynamically adjusted before rendering and during rendering based on the real-time physical environment data, the real-time spatial analysis, and a hardware and software configuration of the user device,
wherein the system enables improved functioning of the user device by minimizing computational overhead through the sandboxed execution, reducing launch latency by invoking the instant application, and enabling secure, adaptive, and spatially consistent digital object interaction based on the real-time spatial analysis.

2. The system of claim 1, wherein the system enables the rendering of an instant, on-demand mixed reality experience without requiring a full application download or redirection to an application storage database.

3. The system of claim 2, wherein enabling the instant, on-demand mixed reality experience comprises:
intercepting a request to access the universal access link; and
in response to user approval through a user interface prompt, activating the modular mixed reality engine.

4. The system of claim 1, wherein the trigger mechanism is associated with embedded metadata related to the mixed reality experience, wherein the embedded metadata comprises at least one of a mixed reality experience identifier, asset locations, or one or more parameters controlling the mixed reality experience.

5. The system of claim 1, wherein the one or more virtual elements comprise at least one digital object placed into the physical environment, wherein the integration of the at least one digital object comprises:
capturing the physical environment data from a set of hardware components associated with the user device;
performing the real time spatial analysis of the physical environment by analysing the on the physical environment data using one or more computer vision algorithms;
generating a spatial map of the physical environment based on the real-time spatial analysis, wherein the spatial map represents at least one of one or more surfaces, one or more objects, one or more boundaries, and one or more reference points; and
determining one or more positions for placing the at least one digital object within the physical environment based on the spatial map and one or more contextual parameters.

6. The system of claim 5, wherein the integration of the at least one digital object comprises persistently anchoring the at least one digital object to the one or more surfaces or the one or more objects in the physical environment such that spatial position and orientation of the at least one digital object remains aligned with the physical environment.

7. The system of claim 5, wherein the determining of the one or more positions comprises evaluating the one or more contextual parameters, wherein the one or more contextual parameters comprise at least an object type, an environment type, spatial constraints in the physical environment, device state, and derived user intent.

8. The system of claim 1, wherein the dynamic placement, the manipulation, and the transformation comprise changing position, altering size, changing orientation, changing texture, or replacing the one or more virtual elements.

9. The system of claim 1, wherein the modular mixed reality engine dynamically loads or unloads one or more mixed reality modules based on monitored system resources and user interaction context, wherein the monitored system resources comprise at least CPU utilization, GPU utilization, battery state, network conditions, or thermal thresholds.

10. The system of claim 1, wherein the trigger signal is generated through the user interaction, wherein the user interaction comprises one of at least:
scanning of a quick response (QR) code through a camera of the user device,
clicking on a hyperlink received on the user device,
detection of a near field communication (NFC) tag through the user device,
reception of a voice input through the user device, and
recognition of a gesture input provided by the user.

11. The system of claim 1, wherein the real-time spatial analysis comprises identifying surfaces, boundaries, reference points, or object geometries within the physical environment.

12. The system of claim 1, wherein the physical environment data comprises at least one or a combination of image data, depth data, and inertial data.

13. A computer-implemented method for executing a dynamic mixed reality experience on a user device, the computer-implemented method comprising:
receiving a trigger signal associated with interaction of a user with a trigger mechanism through the user device, wherein the trigger mechanism comprises a device-agnostic universal access link configured to, upon the user interaction, invoke an instant application without requiring installation;
in response to the trigger signal, activating a modular mixed reality engine configured to dynamically load a plurality of mixed reality modules and digital assets;
executing, using a secure execution framework, the instant application within a sandboxed runtime environment on the user device using the dynamically loaded mixed reality modules and digital assets;
enabling, using the modular mixed reality engine, context-aware, dynamic, and adaptive integration of one or more virtual elements into a physical environment displayed through an adaptive user interface on the user device, wherein the integration is based on real-time physical environment data and real-time spatial analysis; and
rendering the mixed reality experience with the integrated one or more virtual elements on an adaptive and interactive user interface of the user device, wherein the rendering comprises enabling dynamic digital placement, manipulation, and transformation of the one or more virtual elements, wherein the mixed reality experience is dynamically adjusted before rendering and during rendering based on the real-time physical environment data, the real-time spatial analysis, and a hardware and software configuration of the user device,
wherein execution of the method improves functioning of the user device by minimizing computational overhead through the sandboxed execution, reducing launch latency by invoking the instant application, and enabling secure, adaptive, and spatially consistent digital object interaction based on the real-time spatial analysis.

14. The method of claim 13, wherein the trigger mechanism is associated with embedded metadata related to the mixed reality experience, wherein the embedded metadata comprises at least one of a mixed reality (MR) experience identifier, asset locations, and one or more parameters controlling the mixed reality (MR) experience.

15. The method of claim 13, wherein the one or more virtual elements comprise at least one digital object placed into the physical environment, wherein the integration of the at least one digital object comprises:
capturing the physical environment data from a set of hardware components associated with the user device;
performing the real time spatial analysis of the physical environment by analysing the physical environment data using one or more computer vision algorithms;
generating a spatial map of the physical environment based on the real-time spatial analysis, wherein the spatial map represents at least one of one or more surfaces, one or more objects, one or more boundaries, and one or more reference points; and
determining one or more positions for placing the at least one digital object within the physical environment based on the spatial map and one or more contextual parameters.

16. The method of claim 15, wherein the integration of the at least one digital object comprises persistently anchoring the at least one digital object to the one or more surfaces or the one or more objects in the physical environment such that spatial position and orientation of the at least one digital object remains aligned with the physical environment.

17. The method of claim 15, wherein the determining of the one or more positions comprises evaluating the one or more contextual parameters, wherein the one or more contextual parameters comprise at least an object type, an environment type, spatial constraints in the physical environment, device state, and derived user intent.

18. The method of claim 13, wherein the dynamic placement, the manipulation, and the transformation comprise changing position, altering size, changing orientation, changing texture, or replacing the one or more virtual elements.

19. The method of claim 13, wherein the real-time spatial analysis comprises identifying surfaces, boundaries, reference points, or object geometries within the physical environment, and wherein the physical environment data comprises at least one or a combination of image data, depth data, and inertial data.

20. A non-transitory computer-readable storage medium storing computer-executable instructions which, when executed by one or more processors of a computing device, cause the computing device to perform a method comprising:
receiving a trigger signal associated with interaction of a user with a trigger mechanism through the user device, wherein the trigger mechanism comprises a device-agnostic universal access link configured to, upon the user interaction, invoke an instant application without requiring installation;
in response to the trigger signal, activating a modular mixed reality engine configured to dynamically load a plurality of mixed reality modules and digital assets;
executing, using a secure execution framework, the instant application within a sandboxed runtime environment on the user device using the dynamically loaded mixed reality modules and digital assets;
enabling, using the modular mixed reality engine, context-aware, dynamic, and adaptive integration of one or more virtual elements into a physical environment displayed through an adaptive user interface on the user device, wherein the integration is based on real-time physical environment data and real-time spatial analysis; and
rendering the mixed reality experience with the integrated one or more virtual elements on an adaptive and interactive user interface of the user device, wherein the rendering comprises enabling dynamic digital placement, manipulation, and transformation of the one or more virtual elements, wherein the mixed reality experience is dynamically adjusted before rendering and during rendering based on the real-time physical environment data, the real-time spatial analysis, and a hardware and software configuration of the user device,
wherein execution of the stored instructions improves operation of the computing device by enabling secure, lightweight, and low-latency digital object placement and interaction through adaptive module loading and the sandboxed execution suited to devices with limited computational resources.
